(19) United States
(12) Patent Application Publication
(10) Pub. No.: US 2013/0177149 A1
(43) Pub. Date: Jul. 11, 2013

(54) APPLY TIME FOR TEMPORARY ADMINISTRATIVE CHANGES

(71) Applicants: Rodney A. Thomson, Westminster, CO (US); Brian J. Reynolds, Erie, CO (US); Jeff Chu, Arvada, CO (US); Richard S. Youngkin, Littleton, CO (US)

(72) Inventors: Rodney A. Thomson, Westminster, CO (US); Brian J. Reynolds, Erie, CO (US); Jeff Chu, Arvada, CO (US); Richard S. Youngkin, Littleton, CO (US)

(73) Assignee: AVAYA INC., Basking Ridge, NJ (US)

(21) Appl. No.: 13/348,408

(22) Filed: Jan. 11, 2012

(51) Int. Cl. H04M 3/00

(52) U.S. Cl. 379/266.01

(57) ABSTRACT

Methods and systems for supporting manual control of automatic call distribution systems are provided. In particular, an administrator can manipulate parameters associated with call center queues and/or call center agents in order to improve the performance of an in-trouble queue. The changes are reversed after a predetermined period of time has elapsed, and/or after the previously in-trouble queue has returned to a healthy state.

### FIELD

The present invention is directed to the assignment of agents in a contact center. More particularly, embodiments provide for the selective, temporary assignment of agents to contact center queues.

### BACKGROUND

Call center agents are used to provide customer service and support. Commonly, call center agents are assigned to particular queues within the call center. Each queue is adapted to provide particular types of services. For example, different queues can be defined for performing or facilitating different types of transactions with customers.

In connection with the operation of call center queues, it is desirable to minimize caller wait times. In order to maintain service requirements, for example to avoid wait times that are too long, systems have been developed to reallocate agents automatically, or in response to manually administered instructions. Automatic systems have been inflexible, in that they rely on accurate and complete information regarding agent qualifications and queue requirements in order to move agents between queues. In addition, systems that operate autonomously do not benefit from the intuition and experience of human supervisors. Manual systems also have limitations in that the administrator entering changes to the queue assignments must remember to undo those changes when the queue returns to a healthy state, in order to allow the call center to function optimally.

### SUMMARY

Systems and methods that allow an administrator to make temporary changes to call or contact center assignments are provided. More particularly, when an administrator enters a change to queue assignments within a call center, one or more call center parameters are monitored to determine when the temporary assignment can be undone. These parameters can include, but are not limited to, the expiration of a specified period of time, or the return of the queue to a healthy state.

The temporary changes entered by an administrator, such as a contact center supervisor, operations manager, or work force manager, can include assigning additional agents to a queue in trouble, altering the skill level of agents already assigned to a queue in trouble, adjusting the skill level of agents not already assigned to a queue in trouble, or any other adjustment to a parameter used by the automatic call distribution system to assign work to agents.

Methods in accordance with embodiments of the present disclosure can include determining that a queue associated with a contact center is in trouble. The method further includes receiving manually entered instructions from an administrator to increase the number of agents available to service the queue in trouble. After manually administered adjustments have been entered, the automatic call distribution system can monitor the health of the queue. If the queue that was in trouble has returned to a normal, healthy state, the ACD system or application can undo the manually entered changes. Alternatively or in addition, if a predetermined period of time has elapsed since the change was entered manually, that change can be undone. In addition to such automatic resetting of queue related parameters to a normal configuration, an administrator can manually undo changes.

Additional features and advantages of embodiments of the present invention will become more readily apparent from the following description, particularly when taken together with the accompanying drawings.

### BRIEF DESCRIPTION OF THE DRAWINGS

FIG. 1 is a block diagram depicting components of a system in accordance with embodiments of the present invention;

FIG. 2 is a block diagram of an automatic call distribution system in accordance with embodiments of the present invention;

FIG. 3 depicts a user interface in accordance with embodiments of the present invention; and

FIG. 4 is a flowchart depicting aspects of a method in accordance with embodiments of the present disclosure.

### DETAILED DESCRIPTION

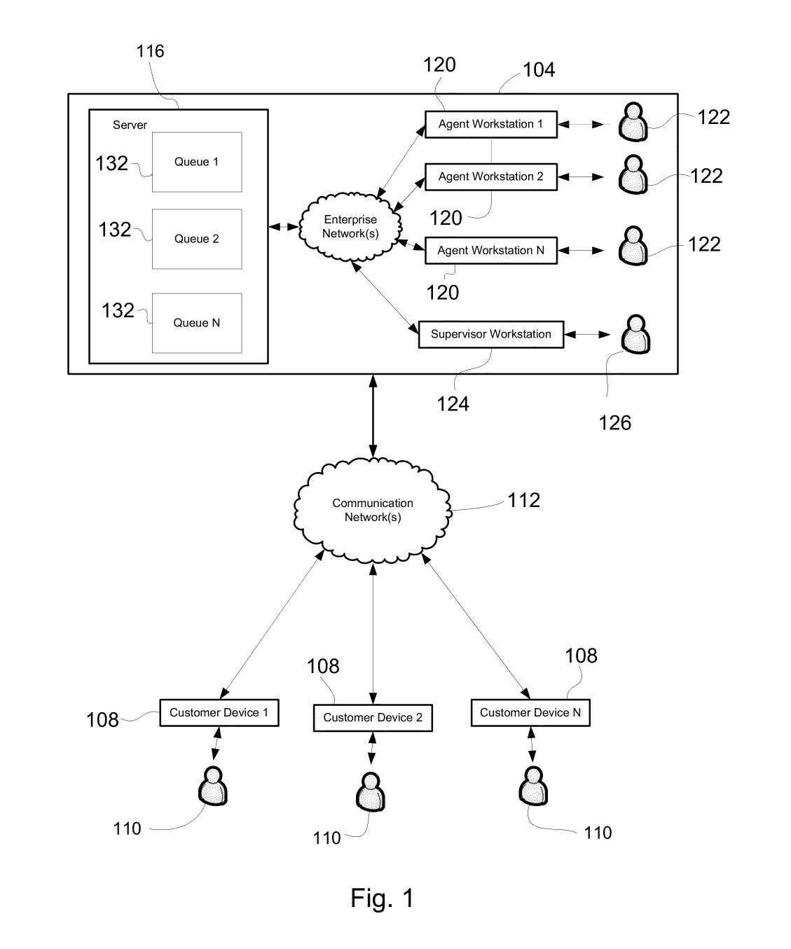

FIG. 1 is a block diagram depicting components of a communication system 100 in accordance with embodiments of the present invention. In particular, the communication system 100 includes a call or contact center 104. In general, the call center 104 is or can be in communication with one or more customer endpoints 108 via one or more communication networks 112. Examples of customer endpoints 108 include, but are not limited to, telephones, cellular telephones, and desktop or mobile computing devices. Moreover, the communications between endpoints 120 associated with the call center 104 and the customer endpoints 108 can comprise voice telephony, video telephony, email, instant messaging, short message system, or other real time or non-real time communications. Each customer endpoint 108 can be associated with a customer 110 who has initiated a contact with or received a contact from the contact center 104. The communication network 112 can include the Internet, a local area network, a wide area network, the public switched telephony network (PSTN), wireless networks, or a plurality of networks in any combination.

The contact center 104 generally includes a call center server, such as an automatic contact (or call) distribution (ACD) system server 116 (hereafter “ACD server 116”). The ACD server 116 is illustratively the MultiVantage™ enterprise communications system-based ACD system available from Avaya Inc. The ACD server 116 is interconnected to a plurality of agent work stations or endpoints 120. Each workstation 120 can be associated with a resource, such as a human agent 122. Alternatively or in addition, an agent workstation 120 can comprise an autonomous resource. In addition, the ACD server 116 can be interconnected to a supervisor or administrator work station 124. The supervisor work station 124 is generally associated with a supervisor, administrator, or other user 126. The agent work stations 120 and the supervisor work station 124 may be connected to the ACD server 116 by a voice and/or data transmission medium or enterprise network 128. The contact center 104 can additionally include other resources 136, such as data repositories or processors.

The ACD server 116 generally functions to connect agent work stations 120 to customer devices or endpoints 108 through the communication network 112, to place customers 110 in communication with agents 122. In addition, the ACD server 116 maintains queues 132 for servicing customer contacts. The different queues 132 can be used to sort contacts from customer endpoints 108 by type, identity of the customer or contact, or otherwise organize contacts or any other attribute or set of attributes. Accordingly, a queue 132 can contain a listing or grouping of customer contacts. Agents 122, associated with the agent workstations 120, are assigned to provide services to contacts that have been placed within one or more of the queues 132 based on availability and/or weighting factors.

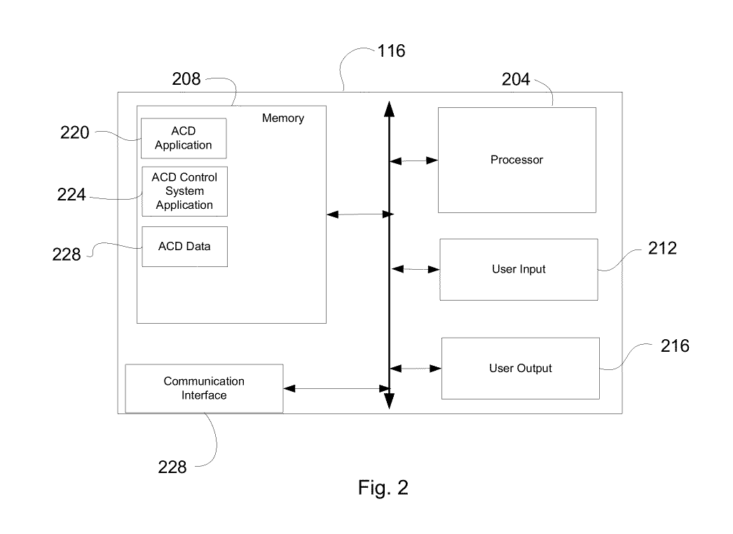

FIG. 2 is a block diagram depicting components of an ACD server 116 in accordance with embodiments of the present invention. In general, the ACD server 116 can comprise or be implemented in connection with a communications server computer that provides or supports connections to associated agent workstations or other resources 136. The ACD server 116 also provides functions to handle contacts from or to customer endpoints 128. The components can therefore include a processor 204 capable of executing program instructions. The processor 204 may include any general purpose programmable processor or controller for executing application programming. Alternatively, the processor 204 may comprise a specially configured application specific integrated circuit (ASIC). The processor 204 generally functions to run programming code implementing various functions performed by the ACD server 116. For example, such functions may include assigning incoming contacts received by the contact center 104 from customer endpoints 108 to agent workstations 120 for handling by associated agents 122. Moreover, as described herein, such functions can include providing support for the temporary reconfiguration or assignments of agents 122 to queues 132 in response to instructions received from an administrator, and for providing automatic mechanisms to reverse such changes.

The ACD server 116 additionally includes memory 208. The memory 208 can be used in connection with the execution of programming by the processor 204, and for the temporary or long term storage of data or program instructions. For example, the ACD server 116 can include an automatic call distribution (ACD) application 220 that is stored in memory 208. As an additional example, the memory 208 may be used in connection with the operation of an ACD control system application 224 stored in the memory 208 that operates as an adjunct to or in cooperation with the ACD system application 212. As described herein, the ACD control system application 224 can provide a user interface for displaying information to and receiving control input from a supervisor or other user 126. The ACD control system application 224 can also implement functions to undo manually entered changes to the ACD system 104 as also described herein. The memory 208 can also function as a store for records or other data 228 related to the ACD queues 132 maintained by the ACD server 116. The memory 208 can include solid state memory that is resident, removable and/or remote in nature, such as DRAM and SDRAM. Alternatively or in addition, the memory 208 can include magnetic, optical or other storage devices. Moreover, the memory 208 can include a plurality of discrete components of different types and/or a plurality of logical partitions.

In addition, one or more user input devices 212 and user output devices 216 may be provided. Examples of user input devices 212 include a keyboard, numeric keypad, touch screen, microphone, scanner, and pointing device combined with a screen or other position encoder. Examples of user output devices 216 include a display, a speaker, and a printer. In general, user input 212 and user output devices 216 are used by an administrator or a supervisor to configure aspects of the operation of the ACD system 116. User input devices 212 and user output devices 216 may be directly connected to the ACD server 116. Alternatively or in addition, user input devices 212 and user output devices 216 can be provided as part of a separate device that is in communication with the ACD server 116, for example by a supervisor device 124. Moreover, a supervisor device 124 can be remote with respect to the ACD system server. One or more communications interfaces 232 can be provided to connect the ACD server 116 to the networks 112 and/or 128.

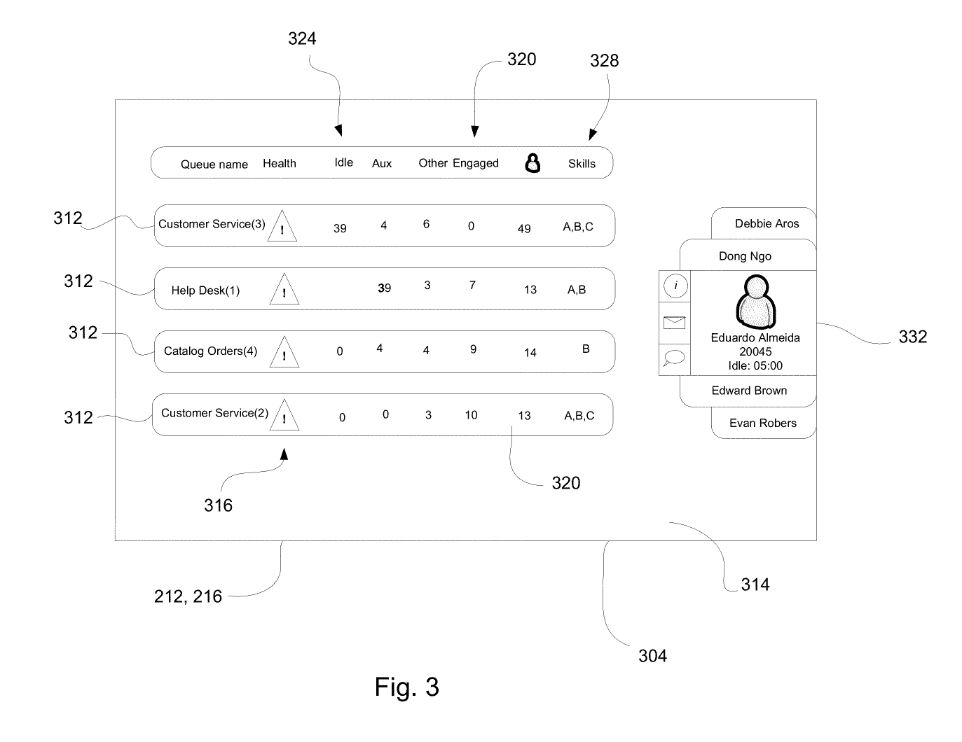

FIG. 3 depicts an exemplary administrator user interface 304 provided by the ACD control system application 224. The user interface 304 can be presented in connection with user input 212 and output 216 devices that are provided by the ACD server 116, or that are provided by a device in communication with the ACD server 116, such as a supervisor device 124. The user interface 304 presents rows of information 312 that relate to different queues 132 maintained by the associated ACD system 116. The queue information 312 can include, for example, a health indication 316 for each of one or more queues 132, the number of agents 122 assigned to each of the one or more queues 132 who are engaged 320, the number of agents assigned to each of the one or more queues 132 who are idle 324, and a required skill identifier or set of identifiers 328 for each of the one or more queues 132. In addition, the user interface 304 can selectively display more detailed information regarding a selected queue 132. For example, information regarding the status of agents 122 assigned to the queue 132 can be presented. As a further example, information regarding a selected agent 122 can be displayed 332. With respect to each agent 122, specific information can be displayed. Such information can include whether the agent is engaged or idle, the percentage of time that the agent is actively engaged, an indication of the agent's skill level for one or a plurality of skills or skill sets, or other information. Moreover, at least some of these parameters with respect to the queues 132 and agents 122 can be manipulated by the supervisor. For example, in response to determining that a queue 132 is in trouble or is in deteriorating condition, the supervisor 126 can choose to take manual action to address the situation. This manual action can include manipulating one or more of the parameters associated with the queue 132 and/or associated with one or more agents 122. Moreover, such entry can be made through direct manipulation of the parameter as displayed by the user interface 304, for example through a touch screen interface provided by the supervisor workstation 124.

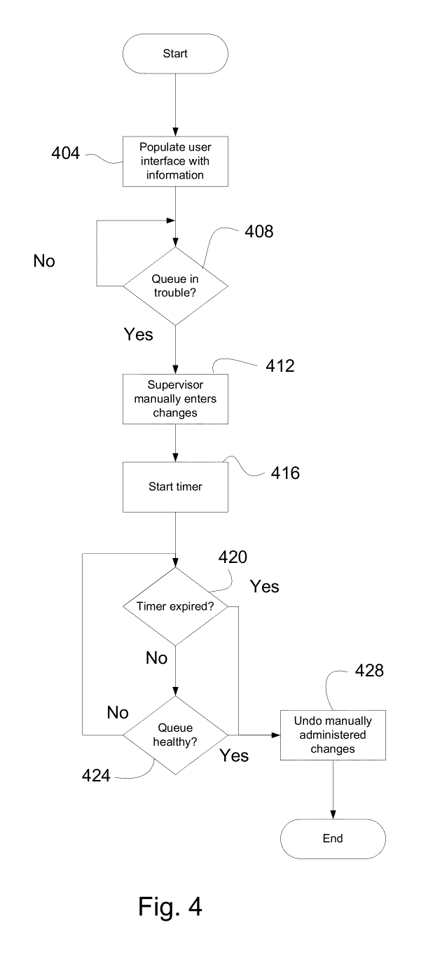

With reference now to FIG. 4, aspects of the operation of a method for facilitating manual control of an ACD server 116 in accordance with embodiments of the present invention are depicted. Initially, at step 404, a supervisor user interface 304 is populated with queue 132 and agent 122 information. This information represents the current state of the contact center 104 and the current assigned parameter values for the queues 132 and/or the agents 122. At step 408, a determination is made as to whether a queue 132 included in the call center system 104 is in trouble. As used herein, a queue 132 may be considered “in trouble” when wait times for customers 110 exceed some predetermined value, when wait times for customers 110 are increasing at some predetermined rate, and the like. Moreover, the determination that a queue 132 is in trouble can be determined objectively (e.g., by the ACD application 220 or ACD control system application 224) or subjectively (e.g., by the supervisor or administrator 126). Until a queue 132 is determined to be in trouble, the process can idle at step 408.

In response to a determination that a queue 132 is in trouble, the supervisor 126 can manually enter changes to the queue 132 or agent 122 parameters, by entering the change parameters in the user interface 304 (step 412). This manual manipulation of the call center 104 parameters can be made regardless of whether the ACD application 220 is also making adjustments to such parameters. Moreover, manually entered changes or input can override automatic changes. Examples of the changes or input that the administrator 126 can enter manually include associating individual agents 122 with a skill or skills that will enable such agents 122 to be assigned work from the in-trouble queue 132, increasing the skill level for agents 122 who are already assigned to the in-trouble queue 132 in order to increase the likelihood that such agents 122 will be assigned work from the in-trouble queue 132, assigning agents 122 from other queues or other work assignments to the in-trouble queue 132, or any other manipulation of agent 122 parameters that will increase the number of agents 122 and/or the skill level of agents 122 assigned to the in-trouble queue 122. Similarly, action taken by the administrator 126 can include reducing the number of required skill and/or skill levels with respect to an in-trouble queue 132. Accordingly, any change to a parameter associated with an agent 122 or a queue 132 can be entered, at the discretion of the administrator 126, in order to improve service quality with respect to the in-trouble queue 132.

After or upon receiving the supervisor 126 input, the ACD control system application 224 starts a timer (step 416). The timer can be implemented as part of the

ACD control system application 224 or separately. At step 420, a determination can be made as to whether the timer has expired (i.e., whether a predetermined or selected period of time has elapsed). The amount of time until the timer elapses can be fixed, variable based on control or ACD system 104 parameters, or selected by the supervisor 126. If the timer has not yet expired, a determination can next be made as to whether the in-trouble queue 132 has returned to a normal state (step 424). Once the timer has expired, or once the previously in-trouble queue 132 is returned to a normal, healthy state, the change or changes to the parameters entered by the administrator 126 at step 312 are reversed or undone (step 428). Operation of the system can then end.

As can be appreciated by one of skill in the art after consideration of the present disclosure, systems and methods provided herein allow a supervisor 126 manual control over parameters that affect the quality of service associated with ACD system 104 queues 132. In addition, by providing for the automatic reversal of manually entered changes upon the expiration of a predetermined period of time or the return of the previously in-trouble queue 132 to a normal state, the administrator 126 is not required to remember to undo the manually entered changes after such changes are no longer needed and/or are no longer desirable.

In accordance with other embodiments, a supervisor 126 can exercise manual control over parameters associated with ACD system 104 queues 132, even when those queues 132 are not in trouble. For example, a supervisor 126 may desire a change for other reasons, for example to temporarily assign an agent 122 to a task outside of their normal work assignment, or for any other reason. The manually entered change can, by operation of the ACD system application 216, be undone after a predetermined period of time has elapsed. In such an embodiment or scenario, the manually entered change would not be undone as a result of the ACD system 104 being in a normal operational state or due to a queue 132 returning from an in-trouble state to a healthy state. For example, when a change is made to a queue 132 while that queue 132 is in a healthy state, the expiration of a timer can be used as a trigger to return that parameter to a previous state automatically, while the health status of the queue 132 can be disabled as a trigger for undoing the change.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A method for controlling an automatic call distribution system, comprising:
establishing at least a first queue;
presenting information regarding the at least a first queue to an administrator;
determining that the at least a first queue is in trouble;
in response to determining that the at least a first queue is in trouble, receiving a manual input from the administrator adjusting a parameter related to the assignment of agents to the first queue;
in response to at least one of determining that a selected period of time has elapsed since the entry was received and determining that the at least a first queue has returned to a normal state, reversing the manual input.

2. The method of claim 1, wherein the manual input is reversed after the expiration of a selected period of time.

3. The method of claim 1, wherein the manual input is reversed after the first queue has returned to a normal state.

4. The method of claim 1, wherein the first queue is established in by an automatic call distribution system server.

5. The method of claim 4, wherein the manual input is received at a supervisor device interconnected to the automatic call distribution system server.

6. The method of claim 5, wherein the supervisor device provides a user interface, wherein the user interface presents the information regarding the at least a first queue to the administrator.

7. The method of claim 6, wherein the interface receives the manual input from the administrator.

8. The method of claim 6, wherein the manual input includes at least one of:
associating an individual agent with a skill that will enable the agent to be assigned work from the first queue; increasing the skill level for agents who are already assigned to the first queue; assigning agents from other queues to the first queue; assigning agents from other work to the first queue; or increasing the number of agents assigned to the first queue.

9. The method of claim 1, wherein the first queue is determined to be in-trouble by an automatic call distribution system control application running on the automatic call distribution system server.

10. The method of claim 1, wherein the first queue is determined to be in-trouble by the administrator in the absence of a determination by an automatic call distribution system (ACD) control system application running on the automatic call distribution system server the first queue is in trouble.

11. The method of claim 1, wherein the first queue contains a listing of contacts that await service by a resource of the automatic call distribution system.

12. A computer readable medium having stored thereon computer executable instructions, the computer readable instructions causing a processor to execute a method for facilitating control of an automatic call distribution system, the computer readable instructions comprising:
instructions to present information related to a health status of a contact center queue to a supervisor;
instructions to accept manual input from the supervisor, wherein the manual input includes input that affects an assignment of resources to the contact center queue;
instructions to reverse the manual input in response to at least one of: an expiration of a predetermined period of time; or a return of the queue to a healthy status.

13. The computer readable medium of claim 12, wherein the information related to the health status of the contact center queue is presented to the supervisor by an output device of a supervisor workstation, and wherein the manual input from the supervisor is received by an input device of the supervisor workstation.

14. The computer readable medium of claim 12, wherein the instructions reverse the manual input in response to the expiration of the predetermined period of time.

15. The computer readable medium of claim 14, wherein the predetermined period of time is selected by the supervisor.

16. The computer readable medium of claim 12, wherein the instructions reverse the manual input in response to a return of the queue to a healthy status.

17. An automatic call distribution system, comprising:
an automatic call distribution (ACD) server, including:
a processor;
memory;
application programming stored on the memory for execution by the processor, wherein the application programming establishes at least a first queue for use in assigning contacts to resources, wherein the application programming is operable to receive commands from an administrator, wherein a command received from an administrator in the form of a manual change affecting assignments of resources to a queue is reversed after at least one of: 1) an expiration of a predetermined period of time; or a return of the queue to a healthy status; or 2) a return of the first queue to a healthy status.

18. The system of claim 17, further comprising:
an administrator work station, including:
a user output, wherein the user output displays information related to the first queue to the administrator;
a user input, wherein the command received from the administrator is received by the user input of the administrator work station.

19. The system of claim 18, wherein the manual change is reversed after the expiration of the predetermined period of time.

20. The system of claim 18, wherein the manual change is reversed after the return of the first queue to a healthy status.
